(19) United States
(12) Patent Application Publication
(10) Pub. No.: US 2007/0004397 A1
(43) Pub. Date: Jan. 4, 2007

(54) Test apparatus for wireless communication components

(75) Inventors: Chan Le, Beaverton, OR (US); Julian Evola, Portland, OR (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/172,062

(22) Filed: Jun. 30, 2005

(51) Int. Cl. H04Q 7/20

(52) U.S. Cl. 455/423

(57) ABSTRACT

A test apparatus including a computer platform having a first portion with expansion interfaces for testing different types of wireless communication components and one or more modular second portions selectively configurable to control testing is described herein.

### TECHNICAL FIELD & BACKGROUND

The present disclosure relates generally to test systems, and more specifically but not exclusively, relates to an apparatus, method, and system for testing of wireless communication components.

Wireless communication components such as network computer cards that provide a desktop or laptop computer with wireless capability are usually tested prior to their sale or use in a product. A variety of tests may be performed to verify the functionality and/or quality of each card. Generally, a card is tested on a computer having a test platform configured to accommodate the particular characteristics of the card. Often, however, as the design of a card evolves or is adapted for use on a new or different device, the original test platform may become unusable or must be substantially reconfigured.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a simplified block diagram of an example computer platform adapted for testing wireless communication components, in accordance with an embodiment;

FIG. 2 illustrates an example flow diagram of a test method associated with the computer platform of FIG. 1, in accordance with an embodiment; and

FIG. 3 illustrates an example system having the computer platform of FIG. 1, in accordance with an embodiment.

### DETAILED DESCRIPTION OF ILLUSTRATIVE EMBODIMENTS

Embodiments of the present invention include, but are not limited to, an apparatus, system, and method for testing one or more wireless communication components or cards.

Various aspects of the illustrative embodiments will be described using terms commonly employed by those skilled in the art to convey the substance of their work to others skilled in the art. However, it will be apparent to those skilled in the art that embodiments of the present invention may be practiced with only some of the described aspects. For purposes of explanation, specific numbers, materials and configurations are set forth in order to provide a thorough understanding of the illustrative embodiments. However, it will be apparent to one skilled in the art that embodiments of the present invention may be practiced without the specific details. In other instances, well-known features are omitted or simplified in order not to obscure the illustrative embodiments.

Various operations will be described as multiple discrete operations, in turn, in a manner that is most helpful in understanding embodiments of the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

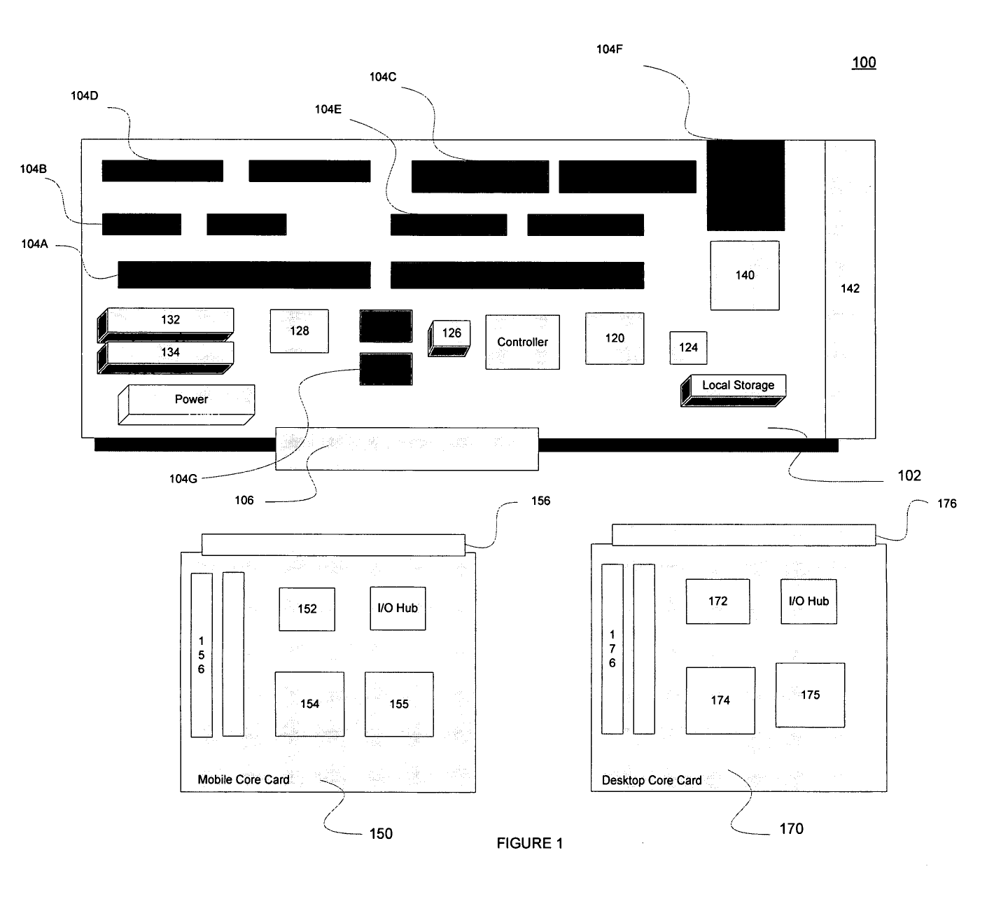

Referring now to FIG. 1, which illustrates a simplified block diagram of a computer platform 100 adapted for testing wireless communication components in accordance with an embodiment of the invention. For the embodiment, computer platform 100 includes a first portion or an input/output (“I/O”) board 102 and one or more modular second portions. In the illustrated embodiment, the one or more modular second portions may include a mobile core card 150 and/or a desktop core card 170. For the embodiment, I/O board 102 has a plurality of expansion interfaces 104A-104G to receive a device under test (DUT). In the embodiment, the DUT may include one or more wireless communication components, e.g., wireless network cards, of same or different types for testing. For example, in an embodiment, the DUT may be a wireless network card suitable for use with a desktop device, such as, for example, a desktop or personal computer, a workstation, or a server. In another embodiment, the wireless communication component may be a wireless network card suitable for use with a mobile device such as a laptop computer, a personal digital assistant (PDA), a wireless email device such as a Blackberry™, or a cellular phone. In an embodiment, a DUT may provide a desktop or mobile device with wireless networking capability according to an IEEE 802.11 standard or protocol, e.g., IEEE 802.11(g) (IEEE=Institute of Electrical and Electronic Engineers).

Additionally, in the embodiment, I/O board 102 has a plurality of expansion interfaces for receiving DUT's having different types of communication interfaces. Thus, as illustrated in the embodiment, I/O board 102 has a plurality of expansion interfaces or slots for receiving a DUT, such as for example, a peripheral control interface (PCI) slot 104A, a mini-PCI card slot 104B, a PCI-Express slot 104C, a PCI-Express mini-card slot 104D, a wireless or other circuit card form factor slot 104E, a Card Bus slot 104F, and a Universal Serial Bus (USB) slot or port 104G. Note that in one embodiment, a mini-PCI or mini-PCI-Express card is functionally similar to a standard desktop computer PCI or PCI-Express card, but having a smaller form factor for use on a mobile device such as a laptop computer. Also note that for clarity in the Figures, only one of each expansion interface or slot has been labeled.

Thus, for the embodiment, mobile core card 150 and desktop core card 170 are selectively configurable to control testing of a feature of a DUT received in an expansion interface 104A-G of I/O board 102, based at least in part on a feature and/or the type of the DUT. In one embodiment, a selected one of mobile core card 150 or desktop core card 170 may be coupled to I/O board 102 to correspond to whether a received type of DUT is usable on a mobile or a desktop device. Accordingly, in the embodiment, mobile core card 150 and desktop core card 170 are removably coupleable to I/O board 102 at a connector 106. In one embodiment, connector 106 may mate with a connector 156 or 176 on a respective mobile or desktop core card 150 or 170. In one embodiment, connectors 106, 156 and 176 may include any suitable type of connector such as a Very High Density Metric (VHDM) connector. Note that in the embodiment, a desktop/mobile power switch 128 is included on I/O board 102 to set an appropriate power level according to a detected mobile or desktop core card 150 or 170 coupled to I/O board 102.

Accordingly, in the embodiment, mobile core card 150 and desktop core card 170 may include a chipset, processor, memory, and Basic Input-Output System (BIOS) configured for a mobile or a desktop computer, respectively. Thus, in the illustrated embodiment, desktop core card 170 includes a desktop chipset 172, desktop processor 174, desktop BIOS 175 and desktop memory 176. In an embodiment, desktop memory 176 may comprise a dual-in line memory module (DIMM) or other suitable memory for a desktop device. Accordingly, in the embodiment, mobile core card 150 may include a mobile chipset 152, mobile processor 154, mobile BIOS 155 and memory 156 for use on a mobile device such as a laptop computer. In one embodiment, memory 156 may be a Small Outline DIMM (SODIMM) or other memory suitable to store instructions on a mobile device to be executed by mobile processor 154 to control testing of a feature of the received DUT. Note that for the embodiment, both mobile and desktop core cards 150 and 170 also include an I/O controller hub as labeled in FIG. 1.

In the embodiment, various features of the DUT may be tested, such as a power consumption feature, an environmental tolerance feature, an outgoing quality feature, or a transmission and reception operability feature. For the embodiment, I/O board 102 includes various electronics to assist in testing such features. Thus, in one embodiment, I/O board 102 includes control logic 120, such as for example, as implemented by a digital I/O controller, to apply testing instructions to the DUT. For example, control logic 120 may control a digital multi-meter (DMM) 124 and power voltage regulator 126 to test a power consumption feature of a DUT. Thus, in one embodiment, DMM 124 is coupled to at least one of expansion interfaces 104A-G to monitor a current and a voltage at a position on I/O board 102. Note that in one embodiment, a USB interface module such as manufactured by ActiveWire Inc., Palo Alto Calif., may be used to provide conversion from USB signals to digital I/O control signals.

I/O board 102 also includes a DUT control 132 to control or manipulate a DUT functionality and a system control 134 for end-user test operation control. I/O board 102 also may include a local area network (LAN) 140 to send and receive testing data and a standard I/O 142 for a keyboard and display. Furthermore, in a lower portion of I/O board 102 and as labeled in FIG. 1, I/O board 102 may also include, in an embodiment, a power supply and a local storage for storing test data, test software, and the like.

Note that in alternate embodiments, the DUT may be a card to provide a desktop or mobile device with one or more capabilities unrelated to wireless networking. For example, in various embodiments, the plurality of expansion interfaces may receive one or more circuit card form factors to add sound, audio or graphics capabilities to a device.

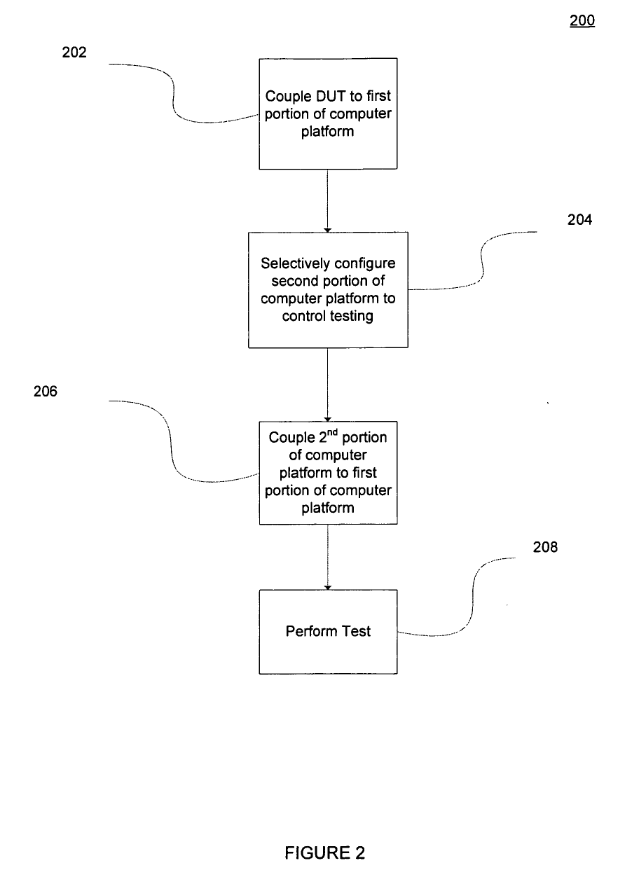

FIG. 2 is an example flow diagram 200 illustrating a test method associated with computer platform 100 of FIG. 1, in accordance with an embodiment. Beginning at a block 202, for the embodiment, one or more wireless communication components of same or different types to be tested, such as for example, a mini-card for use on a mobile device such as a laptop computer, may be removably and correspondingly coupled to mini-PCI card slot 104B of FIG. 1. Next, in the embodiment, at a block 204, a second portion of computer platform 100 or mobile core card 150, is selectively configured to control testing of a feature of the card or DUT, based at least in part on the feature and/or the type of card to be tested. Thus, for example, mobile core card 150 may be configured to have a chipset, processor, BIOS, and memory corresponding to a laptop computer to control testing of the received card.

At a next block 206, mobile core card 150 may be coupled to first portion of computer platform 100 or I/O board 102. Finally, at a block 208, at least one test of at least one feature of the card that has been received in the expansion interface is performed. In the embodiment, control logic 120 (See FIG. 1) may apply testing instructions to the received card, control logic 120 being controllable by selectively configured mobile core card 150.

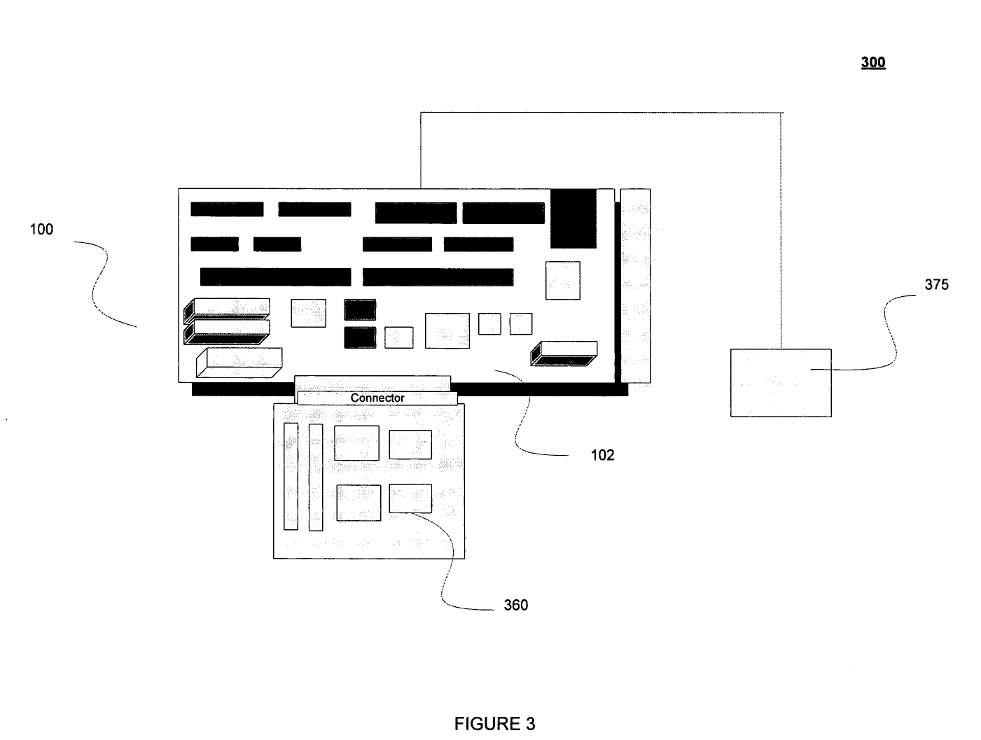

Referring now to FIG. 3, wherein an example system in accordance with an embodiment is shown. Example system 300 includes a first portion or I/O board 102 of a computer platform 100 that has been configured with a plurality of expansion interfaces to receive a corresponding plurality of different types of wireless communication components. For the embodiment, second portion 360 of computer platform 100 has been coupled to I/O board 102, second portion 360 selected to include a processor, memory and/or other electronics to correspond to whether a received type of wireless component is usable on a mobile or desktop device. In an embodiment, second portion 360 may be a core card such as mobile or desktop core card 150 or 170 (see FIG. 1) or other suitable core card that corresponds to a wireless component being tested.

System 300 further also includes a radiofrequency (RF) test unit 375 such as an RF error vector magnitude (EVM) unit, coupled to computer platform 100, test unit 375 to contribute to performing a wireless transmission test on a received wireless communication component to be tested. In an embodiment, test unit 375 may provide signaling and other functions to test a transmission and reception operability feature related to an IEEE 802.11 transmission protocol of the received wireless communication component to be tested. For example, the transmission and reception operability feature may be related to an IEEE 802.11(g) or 802.11(n) protocol.

Accordingly, it can be seen from the above descriptions, a novel apparatus, system, and method for testing one or more wireless communication components or cards have been described. While the present invention has been described in terms of the foregoing embodiments, those skilled in the art will recognize that the invention is not limited to the embodiments described. Embodiments of the present invention can be practiced with modification and alteration within the spirit and scope of the appended claims.

Thus, the description is to be regarded as illustrative instead of restrictive on embodiments of the present invention.

What is claimed is:

1. An apparatus, comprising:
a first portion of a computer platform having a plurality of expansion interfaces to receive one or more wireless communication components of same or different types for testing; and
one or more modular second portion of the computer platform removably coupleable to the first portion of the computer platform and selectively configurable to control testing of a feature of a wireless communication component received in one of the expansion interfaces of the first portion, based at least in part on the feature and/or the type of the received wireless communication component to be tested.

2. The apparatus of claim 1 wherein the feature of the wireless communication component to be tested is selected from the group consisting of a power consumption feature, an environmental tolerance feature, an outgoing quality feature, or a transmission and reception operability feature.

3. The apparatus of claim 1 wherein the wireless communication component is suitable for use with a mobile device selected from a group consisting of a laptop computer, a personal digital assistant, a wireless email device, and a cellular phone.

4. The apparatus of claim 1 wherein the wireless communication component is suitable for use with a desktop device selected from a group consisting of a personal computer, a workstation and a server.

5. The apparatus of claim 1 wherein the plurality of different types of wireless communication components are selected from the group consisting of a peripheral control interface (PCI) card, a mini-PCI card, a PCI-express card, a PCI-express mini-card, a CardBus card, a universal serial bus (USB) device, or a wireless communication card that conforms to an IEEE 802.11 protocol.

6. The apparatus of claim 1 wherein the first portion further includes control logic to apply testing instructions to the received wireless communication component to be tested, the control logic being controllable by the selectively configured modular second portion.

7. The apparatus of claim 1 wherein the first portion of the computer platform has a circuit card form factor.

8. The apparatus of claim 1, wherein the first portion includes a power switch to set a power level according to a detected type of modular second portion of the computer platform removably coupled to the first portion of the computer. platform.

9. The apparatus of claim 1 wherein the one or more modular second portion includes a processor, memory, and BIOS configured based on whether the wireless communication component to be tested is to be used in a mobile device or a desktop device, the memory to store instructions to be executed by the processor to control testing of the feature of the received wireless communication component.

10. The apparatus of claim 1, further comprising a digital multi-meter (DMM) to monitor a current and a voltage at a position of the first portion and coupled to at least one of the expansion interfaces.

11. A method, comprising:
removably and correspondingly coupling one or more wireless communication components of same or different types to be tested, to one or more expansion interfaces of a first portion of a computer platform; and
coupling one or more second portions of the computer platform to the first portion; and
selectively configuring the one or more second portion to control testing of a feature of one of the received wireless communication components, based at least in part on the feature and/or the type of the wireless communication component to be tested.

12. The method of claim 11, wherein the removably and correspondingly coupling the one or more wireless communication components of same or different types comprises coupling a wireless network card selected from the group consisting of a PCI card, a mini-PCI card, a PCI-express card, a PCI-express mini-card, a CardBus card, a universal serial bus (USB) device, or other wireless card that provides a communications function according to a IEEE 802.11 protocol.

13. The method of claim 12 wherein the selectively configuring the one or more second portion of the computer platform to control testing of a feature of one of the received network cards comprises configuring a processor, memory, and BIOS for use on a mobile or a desktop device.

14. A method, comprising:
configuring a first portion of a computer platform with a plurality of expansion interfaces to receive a corresponding plurality of different types of wireless communication components usable with mobile or desktop devices;
coupling a second portion of the computer platform to the first portion of the computer platform, the second portion of the computer platform selected to include a processor and/or a memory to correspond to whether a received type of wireless communication component is usable on a mobile or desktop device; and
performing at least one test of at least one feature of a wireless communication component that has been received in the expansion interface.

15. The method of claim 14, wherein the performing the at least one test includes performing a test of at least one feature selected from the group consisting of a power consumption feature, an environmental tolerance feature, an outgoing quality feature, or a transmission and reception operability feature.

16. A system, comprising:
a first portion of a computer platform having a plurality of expansion interfaces to receive one or more wireless communication components of same or different types for testing;
one or more modular second portion of the computer platform removably coupleable to the first portion of the computer platform and configurable to control testing of a feature of a wireless communication component received in the first portion, based at least in part on the feature and/or the type of the received wireless communication component to be tested; and
a radiofrequency test unit coupled to the first and second portion of the computer platform, the radiofrequency test unit to contribute to testing a feature of the received wireless communication component to be tested.

17. The system of claim 16, wherein the one or more wireless communication components is suitable for use with a desktop device selected from a group consisting of a personal computer, a workstation and a server.

18. The system of claim 16 wherein the one or more wireless communication component is suitable for use with a mobile device selected from a group consisting of a laptop computer, a personal digital assistant, a wireless email device, and a cellular phone.
